(19) United States
(12) Patent Application Publication
(10) Pub. No.: US 2015/0222413 A1
(43) Pub. Date: Aug. 6, 2015

(54) Synchronization in Computer Network

(71) Applicant: Antti Olavi Pietilainen, Espoo (FI)

(72) Inventor: Antti Olavi Pietilainen, Espoo (FI)

(21) Appl. No.: 14/409,060

(22) PCT Filed: Jun. 20, 2012
(86) PCT No.: PCT/EP2012/061879

§ 371 Date: Mar. 27, 2015

(51) Int. Cl. H04L 7/00; H04L 29/08

(52) U.S. Cl. CPC H04L 7/0012; H04L 67/10

(57) ABSTRACT

Methods, apparatus, and computer program products for operating a network node of a computer network are provided. A network node of a first synchronization island detects that at least one communication port(s) of the network node is connected to a network node of a second synchronization island. The first synchronization island and the second synchronization island are synchronized to different master clocks. The network node acquires an announce message from the communication port connected to the second synchronization island, the message including operational parameters of a master clock of the second synchronization island. The operational parameters include a priority parameter representing priority of the master clock of the second synchronization island. The network node overwrites automatically the priority parameter of the message by a new priority parameter indicating the priority of the master clock of the second synchronization island is lower than the priority of master clock(s) of the first synchronization island.

### FIELD

The invention relates to the field of computer networks and, particularly, to synchronization of computer networks.

### BACKGROUND

Modern computer networks may comprise groups of network elements where each group forms a synchronization island synchronized to a master clock. Different synchronization islands are normally synchronized to different master clocks.

### BRIEF DESCRIPTION

According to an aspect of the present invention, there is provided a method as specified in claim 1.

According to another aspect of the present invention, there is provided an apparatus as specified in claim 12.

According to another aspect of the present invention, there is provided an apparatus as specified in claim 23.

According to yet another aspect of the present invention, there is provided a computer program product embodied on a computer readable distribution medium as specified in claim 24.

According to one aspect of the present invention, there is provided a method comprising: detecting, in a network node of a first synchronization island, that at least one communication port of the network node is connected to a network node of a second synchronization island, wherein the first synchronization island and the second synchronization island are synchronized to different master clocks; acquiring an announce message from the communication port connected to the second synchronization island, the announce message comprising operational parameters of a master clock of the second synchronization island, wherein the operational parameters comprise a priority parameter representing priority of the master clock of the second synchronization island; and automatically overwriting the priority parameter of the acquired announce message by a new priority parameter that indicates that the priority of the master clock of the second synchronization island is lower than the priority of the at least one master clock of the first synchronization island.

According to one aspect of the present invention, there is provided an apparatus comprising at least one processor; and at least one memory including a computer program code, wherein the at least one memory and the computer program code are configured, with the at least one processor, to cause the apparatus to: detect that at least one communication port of the apparatus is connected to a network node of a second synchronization island different from a first synchronization island of the apparatus, wherein the first synchronization island and the second synchronization island are synchronized to different master clocks; acquire an announce message from the communication port connected to the second synchronization island, the announce message comprising operational parameters of a master clock of the second synchronization island, wherein the operational parameters comprise a priority parameter representing priority of the master clock of the second synchronization island; and automatically overwrite the priority parameter of the acquired announce message by a new priority parameter that indicates that the priority of the master clock of the second synchronization island is lower than the priority of the at least one master clock of the first synchronization island.

According to one aspect of the present invention, there is provided a computer program product embodied on a distribution medium readable by a computer and comprising program instructions which, when loaded into an apparatus, execute the method comprising: detecting, in a network node of a first synchronization island, that at least one communication port of the network node is connected to a network node of a second synchronization island, wherein the first synchronization island and the second synchronization island are synchronized to different master clocks; acquiring an announce message from the communication port connected to the second synchronization island, the announce message comprising operational parameters of a master clock of the second synchronization island, wherein the operational parameters comprise a priority parameter representing priority of the master clock of the second synchronization island; and automatically overwriting the priority parameter of the acquired announce message by a new priority parameter that indicates that the priority of the master clock of the second synchronization island is lower than the priority of the at least one master clock of the first synchronization island.

Embodiments of the invention are defined in the dependent claims.

### LIST OF DRAWINGS

Embodiments of the present invention are described below, by way of example only, with reference to the accompanying drawings, in which

FIG. 1 illustrates an example of a computer network to which embodiments of the invention may be applied;

FIG. 2 is a flow diagram of a process for modifying priority contents of an announce message according to an embodiment of the invention;

FIG. 3 illustrates modification of the priority parameters of announce messages received from neighbouring network segments according to an embodiment of the invention;

FIG. 4 illustrates an embodiment of a master clock selection algorithm;

FIGS. 5 and 6 illustrate embodiments for modifying other operational parameters of the announce messages;

FIG. 7 illustrates a flow diagram of a process for managing network domain numbers according to an embodiment of the invention;

FIG. 8 illustrates priority parameter accumulation according to an embodiment of the invention; and

FIG. 9 illustrates a block diagram of an apparatus according to an embodiment of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Precision time protocol (PTP) defined by IEEE standard 1588 is an example of clock synchronization in computer networks, e.g. an Ethernet. The IEEE 1588 standard describes a master-slave architecture for clock synchronization and distribution. Under this architecture, a time distribution system comprises one or more network segments and two or more clocks. According to one point of view, a network segment may be defined as a single transmission medium and any devices tapped into it, e.g. two or more communication ports of network nodes sharing the same transmission medium. The transmission medium may be a wired medium, e.g. a cable. At its simplest form, the network segment may be formed by two network nodes both having a communication port connected to the same transmission medium. Through the use of repeaters, further network nodes may share the transmission medium, thus forming a network segment of more than two network nodes each having a communication port connected to the same transmission medium. A network segment may be connected to other network segments through a bridge or router. An ordinary clock may be considered as a device with a single network connection, and it is either a source (master) or destination (slave) of a synchronization reference. The synchronization reference may be used in carrier synchronization and/or time-stamping of data packets, for example. A clock with multiple network connections and ability to bridge synchronization from one network segment to another is called a boundary clock. A synchronization master is elected for each synchronization island of the computer network, wherein each synchronization island may comprise one or more network segments. Thus, the boundary clock may bridge the synchronization between the network segments. A network node providing the synchronization reference is called a grandmaster. The grandmaster transmits synchronization information to the clocks residing on its network segment, and one or more boundary clocks with a presence on that segment then relay accurate time to the other segments to which they are also connected. In this manner, the synchronization is distributed within the synchronization island of the grandmaster and to other synchronization islands through the boundary clocks.

FIG. 1 illustrates an example of a computer network to which embodiments of the invention may be applied. The computer network of FIG. 1 comprises synchronization islands 100, 101, 102. The term “synchronization island” refers to a group of network nodes that autonomously selects a master clock to which clocks of the group are synchronized. Each synchronization island comprises a plurality of network nodes 103 to 122. Synchronization islands 100 to 102 are connected to each other via edge routers 104, 114, 116, 122 called boundary clocks. Additionally, there may be boundary clocks within each synchronization island that do not connect to a neighbouring synchronization island, e.g. boundary clock 115. With respect to the embodiments of the invention described below, the embodiments are realized by the boundary clocks connected to the neighbouring synchronization islands.

Each synchronization island 100 to 102 may comprise at least one master clock 103, 110, 112, 120 called a grandmaster (GM) according to the terminology of the precision time protocol (PTP). The GM provides the synchronization reference primarily used within its synchronization island but, according to embodiments described below, a GM of a neighbouring synchronization island may be used as a backup when the own GM fails. In the example of FIG. 1, the synchronization island 101 comprises multiple master clocks 110, 112 where one of them may provide a synchronization reference, while other master clocks are passive and monitor a situation where the current master providing the synchronization reference becomes inferior in its performance or priority so that another master may take over the provision of the synchronization reference. Furthermore, each synchronization island 100 to 102 may comprise one or more slave clocks 106, 118 that synchronize to a grandmaster clock 103, 110, 112, 120. The slaves may be routers, personal computers, measurement devices, base stations of a wireless communication system such as a cellular communication system, or any terminals.

It should be appreciated that FIG. 1 is a simplified illustration of a computer network, and the computer network may comprise substantially more network nodes, e.g. more boundary clocks, more grandmasters or master clocks, and more slave devices.

The following description contains terminology that originates from the PTP according to the IEEE 1588, but the description is provided in a generic form such that the present disclosure is equally applicable to synchronization methods and protocols other than the PTP.

The grandmasters 103, 110, 112, 120 transmit announce messages that comprise operational parameters of the grandmaster itself. The announce messages may comprise one or more priority parameters of the grandmaster, one or more clock accuracy estimates computed by the grandmaster itself, and/or any classification parameters. The operational parameters may be used in the synchronization island to determine the grandmaster to which to synchronize the clocks of the synchronization island and to determine a hierarchy amongst the grandmasters, when the synchronization island comprises multiple grandmaster candidates, e.g. grandmasters 110, 112. The boundary clocks 104, 114, 116, 122 may define the boundaries of each synchronization island and, thus, the coverage area in which a single grandmaster provides the synchronization reference.

According to an embodiment, the boundary clocks forward the contents of the announce messages between the synchronization islands 100 to 102 such that the synchronization islands are constantly aware of a grandmaster of at least one neighbouring synchronization island that may be used as a backup when the grandmaster(s) of the own synchronization island fails.

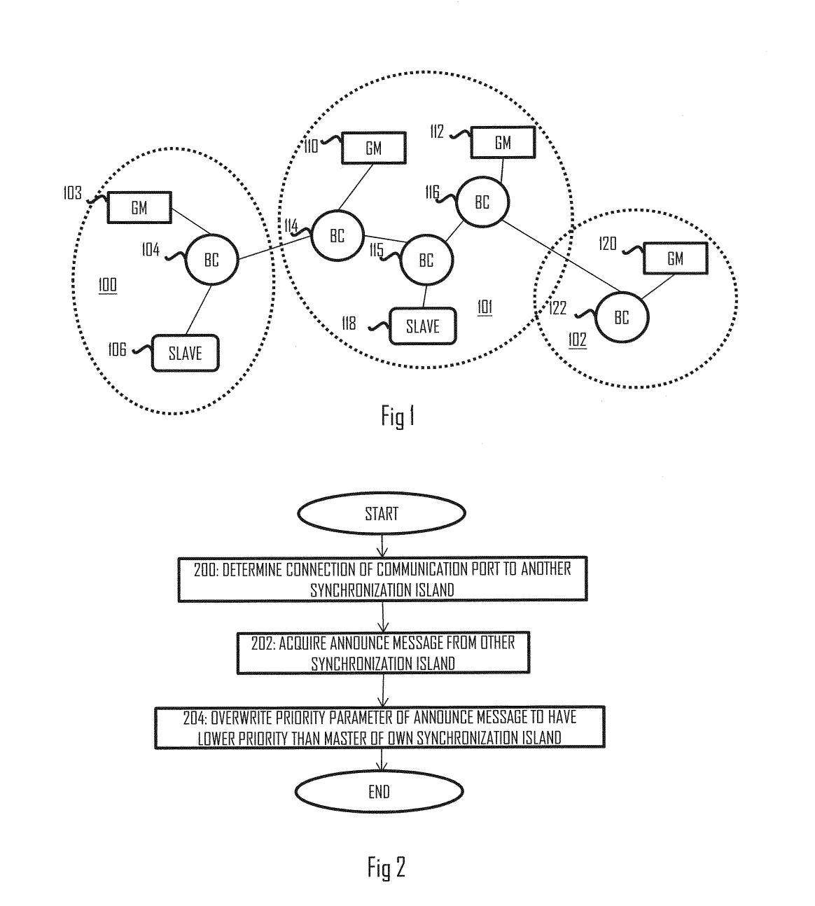

FIG. 2 illustrates an embodiment of a flow diagram of a process for manipulating announce messages received in the boundary clocks 104, 114, 116, 122 from another synchronization island. The manipulation of the announce messages may be used to affect the hierarchy of the grandmasters 103, 110, 112, 120 without requiring changes in a clock selection algorithm, e.g. a best master clock algorithm (BMCA) of the PTP. The process may be carried out as a computer program by at least one processor comprised or applicable to the boundary clock 104, 114, 116, 122. Referring to FIG. 2, a network node of a first synchronization island detects in block 200 that at least one communication port of the network node is connected to a network node of a second synchronization island. This may be determined as a standard procedure when setting up the computer network. The network node of the first synchronization island may be the boundary clock 116 of the synchronization island 101, while the network node of the second synchronization island may be the boundary clock 122 of the synchronization island 102.

In block 202, the network node 116 of the first synchronization island 101 acquires an announce message from the communication port connected to the second synchronization island 102, the announce message comprising operational parameters of a master clock of the second synchronization island 102. The master clock may be the grandmaster 120, and the operational parameters comprise a priority parameter representing priority of the master clock 120 of the second synchronization island 102.

In block 204, the network node 116 automatically overwrites the priority parameter of the acquired announce message and inserts a new priority parameter that indicates that the priority of the master clock 120 of the second synchronization island 102 is lower than the priority of the at least one master clock 110, 112 of the first synchronization island 101. The network node 116 may determine the new priority parameter by a default value stored in a memory of the network node 116, or the new priority parameter may be determined by adding or subtracting a determined amount to resp. from the priority parameter of the acquired announce message or of the current master clock of the network node 116.

After the modification of the announce message, the thus modified contents of the announce message may be forwarded in the synchronization island of the network node, used in master clock selection, and/or processed in another manner. The forwarding may comprise editing a “steps removed” parameter or another parameter representing the number of hops between the boundary clock and the grandmaster of the announce message.

In an embodiment, upon receiving the announce message the boundary clock executes the master clock selection procedure between a grandmaster currently providing the boundary clock with the synchronization reference and the grandmaster of another synchronization island from which parameters were received in the announce message. The boundary clock may use the modified priority parameter in the master clock selection procedure. If the grandmaster currently providing the synchronization reference is deemed to provide a synchronization reference that is better than the grandmaster of the neighbouring synchronization island, the boundary clock may be configured to maintain the synchronization with its current grandmaster and prevent forwarding of the modified contents of the received announce message to its synchronization island. Thus, the other network nodes of the synchronization island of the boundary clock do not become aware of the neighbouring grandmaster. On the other hand, if the grandmaster currently providing the synchronization reference is deemed to provide an inferior synchronization reference than the grandmaster of the neighbouring synchronization island, the boundary clock may be configured to forward the modified contents of the received announce message as a new announce message towards its synchronization island and assume the grandmaster of the neighbouring synchronization island as the new synchronization reference. Thus, another network node of the synchronization island may become aware of the grandmaster of the neighbouring synchronization island. In this manner, the clocks of the computer network may at any time be synchronized to the best grandmaster.

According to PTP standard transparent clocks may be used instead of boundary clocks to forward synchronization information. When a transparent clock is connected to a neighboring island, the transparent clock may simply forward the received announce message with the modified contents towards its synchronization island, e.g. without carrying out the master clock selection procedure.

If a grandmaster receives an announce message comprising parameters of another grandmaster and the grandmaster determines as a result of the master clock selection procedure that the other grandmaster is able to provide a better synchronization reference than itself, the grandmaster may enter a passive state in which it does not provide the synchronization reference or transmit announce messages. For example, the grandmaster 112 may be in the passive state in the example of FIG. 1, and both grandmasters 110 and 112 may become passive when a grandmaster of a neighbouring synchronization island 103, 120 provides the best synchronization reference. Upon detecting on the basis of the received further announce messages that the situation has changed and that the performance of (an)other grandmaster(s) has degraded and that the grandmaster itself is capable of providing a better synchronization reference, the grandmaster may enter an active mode and start providing the synchronization reference and transmitting the announce messages. From a viewpoint, the synchronization in the computer network may be understood in such manner that the grandmasters each have their synchronization islands, and certain boundary clocks define the boundaries of the synchronization islands. Even when the grandmaster(s) of a synchronization island fail and the clocks synchronize to a grandmaster of a neighbouring synchronization island, the boundaries of the synchronization island may be considered to remain, and the two synchronization islands may be understood as being synchronized to the same grandmaster but still belonging to different synchronization islands. When the grandmaster of the synchronization island again gains sufficient synchronization performance, all the clocks of the synchronization island once again synchronize to their own grandmaster. As a consequence, a grandmaster of a neighbouring synchronization island may be used as a temporary backup.

The embodiment of FIG. 2 provides a procedure, where the boundary clock or another network node of a synchronization island manipulates the priority parameters of the announce messages received from neighbouring synchronization islands such that the master clock(s) of the own synchronization island are preferred in the best master clock selection procedure, but that the synchronization to the grandmasters of the neighbouring islands is nevertheless allowed, e.g. in a case where the grandmaster(s) of the own synchronization island becomes unstable, broken, or unreachable. Accordingly, the loss of synchronization may be avoided.

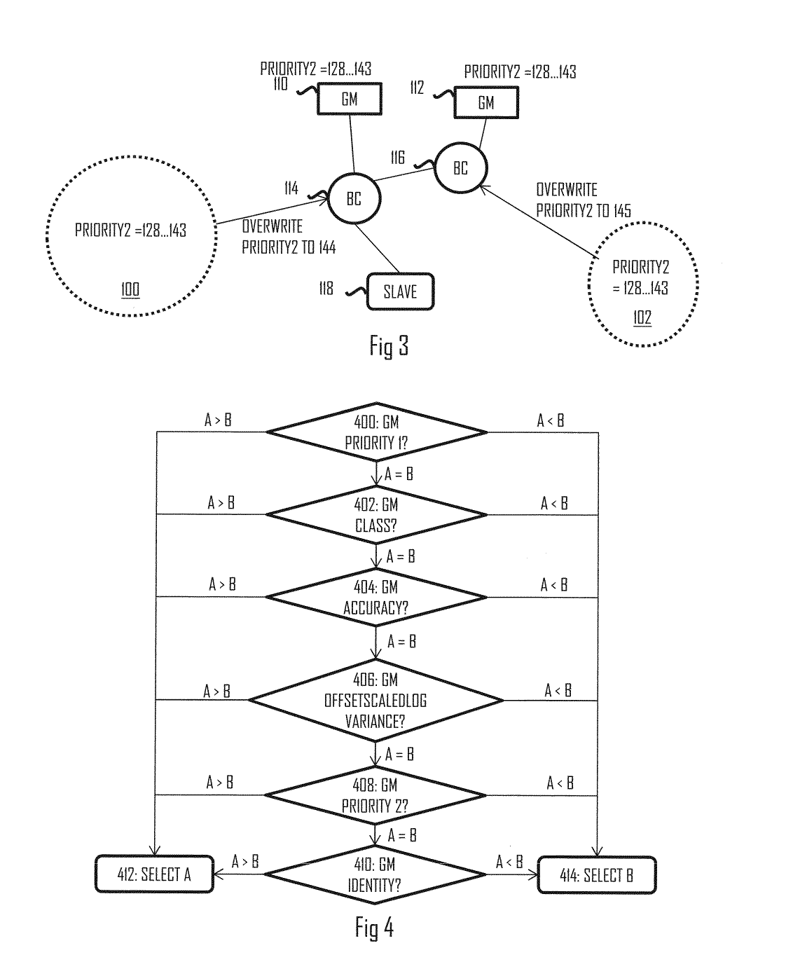

FIG. 3 illustrates a portion of the computer network of FIG. 1 in the context of the embodiment of FIG. 2. The boundary clocks 114, 116 of the synchronization island 101 are connected to respective neighbouring synchronization islands 100, 102. The grandmaster 110, 112 of the synchronization island 101 may have an arbitrary priority value within a determined priority value range. This embodiment is described in connection with the PTP and, thus the priority parameter is Priority2 parameter of the PTP. Priority2 parameter resides in a lower level in parameter hierarchy than a higher level Priority1 parameter of the PTP. Priority1 may be used to manually enforce utilization of determined grandmasters, while Priority2 may be used for the above-described purpose of automatically favouring a grandmaster of own synchronization island while accepting auxiliary grandmaster from a neighbouring island in case of own grandmaster(s) fail(s). PTP parameters are discussed in greater detail below with reference to FIG. 4.

Let us assume that the grandmaster 110, 112 currently providing a synchronization reference is assigned with priority (Priority2) parameters between a range 128 and 143. Similarly, grandmasters of the other synchronization islands 100, 102 may be assigned with priority parameter values within the same range in their respective islands 100, 102. In the PTP, a lower value of the priority parameter indicates a higher priority, but in other networks the situation may be opposite, e.g. a higher value of the priority parameter may indicate a higher priority. Therefore, the reader is advised to look beyond the absolute numerical values and appreciate the priority hierarchy in the described embodiment(s).

With the assumption that the priority parameter values between 128 and 143 are reserved for the grandmaster of the own synchronization island 101, the boundary clocks 114, 116 may be configured to overwrite the priority (Priority2) parameter of the announce messages received from the neighbouring synchronization islands 100, 102 with a value that indicates a lower priority than the corresponding priority of the grandmaster in the own synchronization island. For example, the boundary clocks 114, 116 may overwrite a value in the priority parameter of the received announce message with a parameter value that is higher than 143.

In an embodiment, the boundary clocks 114, 116 of the same synchronization island 101 are configured to modify the contents of the received announce messages with the same priority parameter values, thus providing the neighbouring synchronization islands 100, 102 with the same priority in the own synchronization island 101.

In another embodiment, the synchronization island prioritizes the neighbouring synchronization islands, e.g. the boundary clock 116 may replace a priority parameter value of the announce message received from island 102 with a priority parameter value indicating a lower priority than a priority parameter value the boundary clock 114 uses to modify a parameter value of an announce message it receives from the island 100. As shown in FIG. 3, the boundary clock 114 may overwrite the priority parameter value of the announce message received from island 100 with value 144, while the boundary clock 116 may overwrite the priority parameter value of the announce message received from island 102 with value 145, thus prioritizing a grandmaster or grandmasters of island 100.

Let us now consider a clock selection algorithm used in the PTP with reference to FIG. 4. The clock selection algorithm follows the BMCA specified in the PTP standard while using the overwritten Priority2 parameters when comparing a grandmaster of the neighbouring synchronization island with a grandmaster currently providing the synchronization reference. The flow diagram of FIG. 4 illustrates the BMCA when comparing two grandmasters A and B in selecting a grandmaster to provide the clock synchronization. The BMCA is a hierarchical selection algorithm that considers sequentially different criteria between two grandmasters until it finds a difference between the parameters of the grandmasters. Referring to FIG. 4, the first criterion is Priority1 criterion in which the Priority1 parameters of the grandmasters A and B are compared, and a grandmaster with the highest priority as defined by the Priority1 parameter is selected. For example, if grandmaster A has a higher priority than grandmaster B, the process proceeds to block 412 in which the grandmaster A is selected as the synchronization source. If the grandmaster B has a higher priority than grandmaster A, the process proceeds to block 414 in which the grandmaster B is selected as the synchronization source. If the priorities are equal, the process proceeds to block 402 in which grandmaster classifications of the grandmasters A and B are compared. The clock class is a measure of clock accuracy in terms that it may specify the type of reference clock of the grandmaster, or it may also indicate that the grandmaster has lost the ability to synchronize to a primary reference source and is in holdover mode, either within or not within the holdover specifications. Again, if either one of the grandmasters provides a higher class parameter in terms of performance of the grandmaster, that grandmaster is selected. If the Class parameters are equal, the process proceeds to block 404 in which grandmaster clock accuracy estimates are compared. The clock accuracy estimate may be an estimate computed by each grandmaster for itself. In block 404, a grandmaster with better clock accuracy estimate is selected or, otherwise, the process proceeds to block 406 in which clock variance estimates (OffsetScaledLogVariance) of the grandmasters A, B are compared. The clock variance estimates are also performance estimates representing clock stability of the grandmaster clocks, and the grandmaster with better clock variance estimate is selected. Otherwise, the process proceeds to block 408 in which the second priority parameter (Priority2) is evaluated. This priority value may have been manipulated in the boundary clock(s) according to embodiments of the invention, and a grandmaster with a higher priority as indicated by the Priority2 parameter is selected. If the priorities are equal, the process proceeds to block 410 in which grandmaster identity parameters are compared. Block 410 is a comparison between the identities of the grandmasters, and the grandmaster may be selected according to a determined criterion, e.g. a grandmaster having a lower identifier value may be selected.

The BMCA may be executed periodically, e.g. every few seconds, and/or upon detecting a determined event in the network or in the boundary clock, e.g. loss of connection with the serving grandmaster or reception of an announce message in the boundary clock.

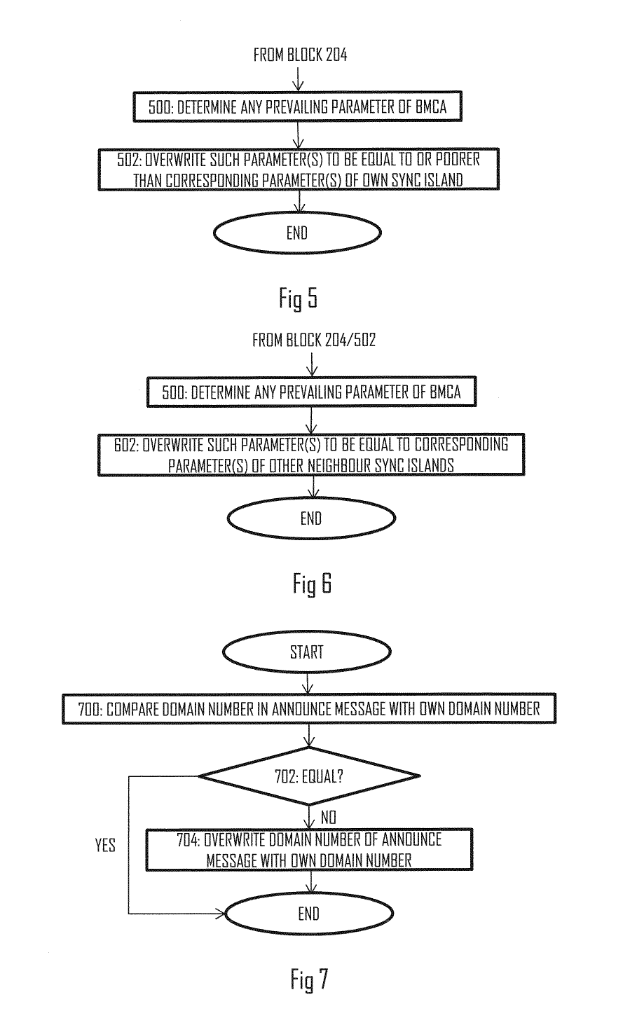

In the embodiments where the master clock selection procedure is sequential in the above-described manner and there is at least one criterion prevailing over the priority2 parameter overwritten by the boundary clock(s) in the procedure, e.g. the clock accuracy estimate comparison, the boundary clock(s) 104, 114, 116, 122 modifying the received announce messages may be configured to carry out a check routine to check such operational parameters of the grandmaster from the received announce message. Then, the boundary clock(s) 104, 114, 116, 122 may modify those operational parameters to ensure that the priority parameter will be used in the selection between the grandmaster clocks. FIGS. 5 and 6 illustrate embodiments for manipulating the other parameter values of the announce message.

Referring to FIG. 5, it is determined in block 500 whether the best master clock selection algorithm uses at least one other criterion that prevails over the above-mentioned priority of the master clocks in the algorithm and, e.g. Priority2 of the PTP. If such criterion is provided, operational parameters of the announce message that affect the at least one other criterion are also determined in block 500. In block 502, parameter values of the determined operational parameters in the acquired announce message are overwritten with parameter values that are equal to or poorer than the corresponding parameter values of the own synchronization island. In this manner, the boundary clock or, in general, the network node carrying out the procedure modifies the operational parameters that are higher in the selection tree of FIG. 4, and the parameter values of the modified operational parameters are selected to be equal to or even poorer than the corresponding operational parameters of any grandmaster in the synchronization island of the network node. Accordingly, the master clock selection algorithm carried out in the synchronization island of the network node selects the grandmaster of the own synchronization island or proceeds to the next step in the clock selection algorithm in blocks 400 to 406 of FIG. 4.

Referring to FIG. 6, block 500 is carried out first to determine whether the best master clock selection algorithm uses at least one other criterion that prevails over the priority of the master clocks in the algorithm and, if such criteria is provided, operational parameters that affect the at least one other criterion are determined.

In block 602, the parameter values of the determined operational parameters in the acquired announce message are overwritten with parameter values that are equal to the corresponding parameter values of another neighbouring synchronization island also connected to the synchronization island of the network node. This procedure ensures that only the priority parameter affects the selection of the grandmaster of the neighbouring domain in the master clock selection procedure. This embodiment may be realized by configuring all the boundary clocks of the same synchronization islands that are connected to neighboring islands, to carry out the embodiment of FIG. 5 in the same manner. For example, the boundary clocks carrying out the procedure modify the operational parameters that are higher in the selection tree of FIG. 4 in the same manner, and the parameter values of the modified operational parameters are selected to be equal to the corresponding operational parameters of all grandmasters in the synchronization island of the network node, and all boundary clocks apply the same operational parameters to the acquired announce messages. As a consequence, the master clock selection algorithm carried out in the synchronization island of the network node proceeds to the next step in the clock selection algorithm in blocks 400 to 406 of FIG. 4 regardless of whether it evaluates the grandmaster of the own synchronization island with another grandmaster of its own or a grandmaster of another neighbouring synchronization island.

The procedure of FIG. 6 may be carried out in connection with the procedure of FIG. 5, or the network node may carry out only one of the procedures of FIGS. 5 and 6. In an embodiment, blocks 502 and 602 are processed jointly, and the network node may consider both the parameter values of the grandmaster in the own synchronization island and the parameter values of the grandmaster in the neighbouring synchronization island when selecting the parameter value used to overwrite the parameter value in the announce message.

In order to ensure that the procedures of FIGS. 5 and 6 do not cause the selection of poorly operating grandmaster of a neighbouring synchronization island, the network node may employ a safety mechanism that prevents the network node to falsely make a neighbouring grandmaster to appear to have a higher quality than what it actually has. In an embodiment, the safety mechanism may comprise preventing the network node to improve the higher priority (e.g. Priority1) or the performance estimate (e.g. Class, Accuracy, OffsetScaledLogVariance) parameter values. Accordingly, poorly operating neighbouring grandmaster will not falsely appear as working properly.

In another embodiment, the network node is allowed to improve the higher priority (e.g. Priority1) and/or the performance estimate(s) (e.g. Class, Accuracy, OffsetScaledLogVariance) parameter values such that the Priority2 parameter will become the parameter that realizes the selection of the grandmaster.

In yet another embodiment, the computer network may be configured to maintain the parameters prevailing over the priority2 parameter as default values that are static and equal in different synchronization islands. An exception may be the clock class parameter which indicates whether or not the grandmaster has an operating clock reference. Accordingly, the unstable grandmasters are filtered out, and the operating grandmasters have the same clock class parameter value, and the master clock selection is made on the basis of the priority2 parameter values of the grandmasters.

When networks are developed, a network node which is not provided with the functionality of overwriting the priority parameter values of received announce messages may be installed as the boundary clock between two synchronization islands. This may result in that unmodified announce messages of neighbouring synchronization islands are distributed in the synchronization island of such a boundary clock, and it may lead to the selection of an undesired grandmaster of a neighbouring synchronization island. In an embodiment, the synchronization islands are assigned with unique domain numbers. Accordingly, a boundary clock not provided with the overwriting functionality discards PTPmessages, except management messages received from a synchronization domain having a domain number different from the domain number of the domain of the boundary clock itself. According to an embodiment, the network node provided with the overwriting functionality is also configured to carry out the operation of FIG. 7. Referring to FIG. 7, the network node compares the domain number of the received announce messages and other messages with the domain number of the synchronization domain of the network node in block 700. If the domain numbers are equal (block 702), the process ends. If the domain numbers are different, the domain numbers of the messages, including or excluding management messages, are overwritten (block 704) with the domain number of the synchronization island of the network node and then the other fields are modified. If some neighbouring domains should be kept independent, the range of domain numbers may be divided into two sub-ranges. One range may be overwritten as described above and the other may not be overwritten, resulting in that the islands remain unaware of each other.

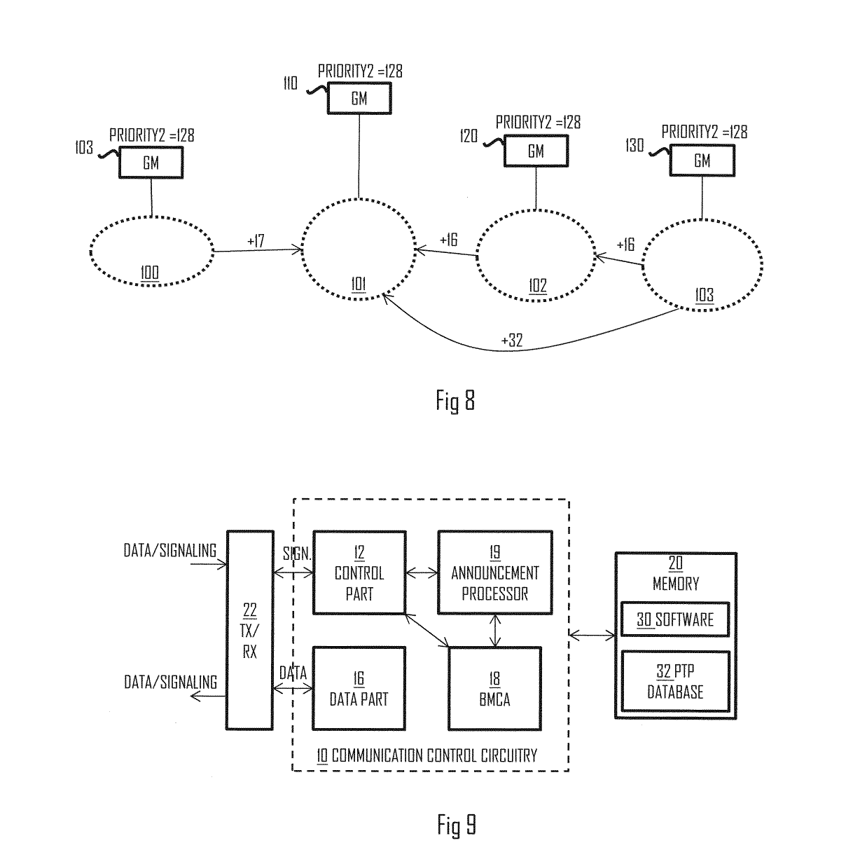

In embodiments where the grandmasters of the neighbouring synchronization islands are assigned with the same priority parameter value, a problem may arise in the sense that clocks of a synchronization island may select a very remote grandmaster as the reference clock. Typically, the performance of the synchronization improves when the grandmaster is close to the slave clock. In order to prefer a grandmaster close to the synchronization island over a remote grandmaster, an embodiment of the invention provides priority accumulation functionality in the network node(s) overwriting the priority parameters of the received announce messages. The network node may determine the new priority parameter by accumulating an original priority parameter contained in the acquired announce message by a predetermined amount. FIG. 8 illustrates the effect of the accumulation. Referring to FIG. 8 illustrating synchronization islands 100, 101, 102, and 103, let us assume that a boundary clock of the synchronization island 101 accumulates the priority parameter of each announce message received from the synchronization island 100 by value 17. Furthermore, the boundary clock or another boundary clock having a communication port connected to the synchronization island 102 accumulates the priority parameter of each announce message received from the synchronization island 102 by value 16. Accordingly, the synchronization island 102 is prioritized over the synchronization island 100 by assigning a lower accumulation value to it, provided that the priority parameters in the announce messages received from the domains 100, 102 are equal. In this example, all grandmasters 103, 110, 112, 120, 130 have the same priority parameter value 128 in their respective synchronization islands.

Let us further assume that a boundary clock of the synchronization island 102 accumulates the priority parameter of each announce message received from synchronization island 103 by value 16 before distributing the announce message towards the synchronization island 102. This results in that when the announce message comprising the parameters of the grandmaster of the synchronization island 103 is distributed to the synchronization island 101, the boundary clock of the synchronization island 101 further accumulates the priority parameter by the value of 16, thus resulting in overall accumulation of the priority parameter by 32, as shown in FIG. 8. This results in the following priority value situation in the synchronization island 101:

TABLE 1

| Grandmaster | Priority value in domain 101 |
|---|---|
| GM 103 | 145 |
| GM 110 | 128 |
| GM 120 | 144 |
| GM 130 | 160 |

As a consequence, the grandmasters of the own synchronization island (101 in this case) are preferred over the grandmasters of the neighbouring domains 100, 102, 103. If all the grandmasters of the own synchronization island become unstable, the grandmaster 120 of the island 102 is prioritized next, then the grandmaster 103 of the island 100 and, as the last option, the grandmaster 130 of the remote island 103. This results in that the grandmaster of the own synchronization island has the highest priority, and grandmasters of the neighbouring synchronization islands have a priority that decreases in proportion to the distance to the own synchronization island.

The accumulation value used to accumulate the priority parameter values of the announce messages received from the neighbouring synchronization island(s) may be selected sufficiently high such that it leaves sufficient range of priority parameter values for use in prioritizing the grandmasters of the neighbouring synchronization island(s). In an embodiment, the accumulation value is higher than one to allow the prioritization between the grandmaster of the own synchronization island and at least one grandmaster of a neighbouring synchronization island. In another embodiment, the accumulation value is higher than five to provide more flexibility in the prioritization between the own island and the neighbouring islands, and yet in another embodiment the accumulation value is higher than ten to provide even more flexibility. The accumulation value may be a fixed or semi-static parameter selected according to the size of the synchronization island and the computer network, for example.

FIG. 9 illustrates an embodiment of an apparatus comprising means for carrying out the above-mentioned functionalities of the network node modifying the priority parameters contained in the received announce messages. The apparatus may be the above-mentioned boundary clock which complies with PTP specifications or with specifications of another synchronization scheme where a network node may acquire synchronization from a grandmaster of a neighbouring synchronization island or even from a remote grandmaster. The apparatus may be a router, e.g. an edge router configured to connect to at least one network segment and/or synchronization island. The apparatus may, however, be or may be comprised in another type of network node, e.g. a computer (PC), a measurement device, an industrial device, a base station of a wireless communication system, or a consumer electronic device. According to another aspect, the apparatus carrying out the above-described functionalities is comprised in such a network node, e.g. the apparatus may comprise a circuitry, e.g. a chip, a processor, a micro controller, or a combination of such circuitries in the network node.

Referring to FIG. 9, the apparatus may comprise a communication controller circuitry 10 configured to control communications in the apparatus. The communication controller circuitry 10 may comprise a control part 12 handling control signalling communication with respect to transmission, reception, and extraction of control messages including the announce messages, as described above. The control part 12 may handle communication through multiple communication ports and determine which communication port(s) is/are connected to the neighbouring network segments and/or synchronization islands. The control part 12 may process the announce messages received from a communication port connected to a neighbouring network segment and forward them to an announcement processor circuitry 19 for the modification. Upon receiving modified contents of the announce message from the announcement processor circuitry 19, the control part 12 may distribute the parameters of the grandmaster to at least one communication port connected to the synchronization island of the apparatus. Furthermore, the control part 12 may control the transmission of the announce messages comprising the modified contents over at least one communication port connected to a neighbouring network segment other than from what it received the original announce message. The control part may prevent transmission of the modified contents of the announce message to the neighbouring network segment from which it received the announce message.

The communication controller circuitry 10 may further comprise a data part 16 handling transmission, processing, and reception of payload data according to state-of-the-art data routing and processing procedures. The data part 16 may utilize in the data transfer the synchronization acquired according to principles of the embodiments described herein.

The communication controller circuitry 10 may further comprise the announcement processor circuitry 19 configured to process the announce messages received by the control part 12 from the neighbouring network segment(s). The announcement processor circuitry 19 may be configured to modify at least the priority parameter of the announce message, as described above. The announcement processor circuitry 19 may be configured to modify the priority parameter such that new priority parameter value inserted into the announce message indicates lower priority than the priority of any or all the grandmasters in the synchronization island of the apparatus. In some embodiments, the announcement processor circuitry 19 is also configured to modify other parameter values of the announce message, as described above.

The communication controller circuitry 10 may further comprise a master clock selection circuitry 18 configured to select the grandmaster for the clock synchronization reference. The master clock selection circuitry 18 may employ the BMCA procedure, for example. The master clock selection circuitry 18 may receive from the control part 12 and/or from the announcement processor circuitry 19 the operational parameters of the grandmasters to be used in the master clock selection. The control part 12 may input to the master clock selection circuitry 18 any announce message received from a communication port connected to the synchronization island of the apparatus, e.g. unmodified announce messages, while the announcement processor circuitry 19 may input to the master clock selection circuitry the modified announce messages received by the control part 12 from communication port(s) connected to the neighbouring synchronization island(s).

The circuitries 12 to 19 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 12 to 19 or all of them.

The apparatus may further comprise the memory 20 that stores computer programs (software 30) configuring the apparatus to perform the above-described functionalities in the network node. The memory 20 may also store communication parameters and other information needed for the operation of the synchronization and processing and distributing the announce messages. The apparatus may further comprise communication interface components 22 providing the apparatus with communication capabilities within the network segment(s) and synchronization island(s) to which the apparatus is connected. The communication interface components 22 may comprise the communication ports and any standard physical components to realize physical layer connections with other network nodes. The apparatus may further comprise a user interface enabling interaction with the user of the communication device. The user interface may comprise a display, a keypad or a keyboard, a loudspeaker, or the user interface may be a software-based user interface, e.g. a web-based client application.

In an embodiment, the apparatus carrying out the embodiments of the invention in the network node comprises at least one processor and at least one memory including a computer program code, wherein the at least one memory and the computer program code are configured, with the at least one processor, to cause the apparatus to carry out the functionalities according to any one of the processes of FIGS. 2 to 8. Accordingly, the at least one processor, the memory, and the computer program code form processing means for carrying out embodiments of the present invention in the network node.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIGS. 2 to 8 may also be carried out in the form of a computer process defined by a computer program. The computer program may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to computer networks such as packet-based local area networks (LAN) but also to other suitable computer networks, e.g. transport networks of cellular communication systems, Ethernet networks or optical transport networks. The protocols used, the specifications of computer networks, their network elements and user terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A method comprising:
detecting, in a network node of a first synchronization island, that at least one communication port of the network node is connected to a network node of a second synchronization island, wherein the first synchronization island and the second synchronization island are synchronized to different master clocks;
acquiring an announce message from the communication port connected to the second synchronization island, the announce message comprising operational parameters of a master clock of the second synchronization island, wherein the operational parameters comprise a priority parameter representing priority of the master clock of the second synchronization island; and
automatically overwriting the priority parameter of the acquired announce message by a new priority parameter that indicates that the priority of the master clock of the second synchronization island is lower than the priority of the at least one master clock of the first synchronization island.

2. The method of claim 1, further comprising determining the new priority parameter by accumulating an original priority parameter contained in the acquired announce message by a predetermined amount.

3. The method of claim 1, further comprising:
determining whether a best master clock selection algorithm used by the network node uses at least one other criterion that prevails over said priority of the master clocks in the algorithm and, if such criteria is provided, determining operational parameters that affect the at least one other criterion; and
overwriting parameter values of the determined operational parameters in the acquired announce message with parameter values that are equal to or poorer than the corresponding parameter values of the master clock of the first synchronization island.

4. The method of claim 1, further comprising:
determining whether a best master clock selection algorithm used in the network node uses at least one other criterion that prevails over said priority of the master clocks in the algorithm and, if such criteria is provided, determining operational parameters that affect the at least one other criterion; and
overwriting parameter values of the determined operational parameters in the acquired announce message with parameter values that are equal to the corresponding parameter values of a master clock of a third synchronization island also connected to the first synchronization island.

5. The method of claim 3, wherein the at least one criterion that prevails over said priority of the master clocks in the algorithm comprises at least one of the following: a manual master clock priority, a master clock classification, a master clock accuracy, and a master clock stability.

6. The method of claim 1, further comprising:
providing the first synchronization island and the second synchronization island with unique domain number parameters; and
overwriting a domain number parameter of the acquired announce message with a value that is equal to a domain number parameter value of the first synchronization island.

7. The method of claim 1, further comprising using thus modified contents of the acquired announce message in a master clock selection algorithm configured to select a master clock for the network node.

8. The method of claim 1, further comprising forwarding thus modified contents of the announce message towards the first synchronization island.

9. The method of claim 8, further comprising before forwarding the contents of the announce message:
executing a master clock selection algorithm in which the master clock of the second synchronization island is compared with a master clock of the first synchronization island;
upon determining on the basis of the master clock selection algorithm that the master clock of the second synchronization island is capable of providing a better synchronization reference than the master clock of the first synchronization island, forwarding the modified contents of the announce message in the first synchronization island; and
upon determining on the basis of the master clock selection algorithm that the master clock of the first synchronization island is capable of providing a better synchronization reference than the master clock of the second synchronization island, preventing the forwarding of the modified contents of the announce message in the first synchronization island.

10. The method of claim 1, further comprising forwarding the announce message with the modified contents towards the first synchronization island.

11. The method of claim 1, wherein the priority parameter is Priority 2 parameter of precision time protocol according to IEEE 1588 specification.

12. An apparatus comprising:
at least one processor; and
at least one memory including a computer program code, wherein the at least one memory and the computer program code are configured, with the at least one processor, to cause the apparatus to:
detect that at least one communication port of the apparatus is connected to a network node of a second synchronization island different from a first synchronization island of the apparatus, wherein the first synchronization island and the second synchronization island are synchronized to different master clocks;
acquire an announce message from the communication port connected to the second synchronization island, the announce message comprising operational parameters of a master clock of the second synchronization island, wherein the operational parameters comprise a priority parameter representing priority of the master clock of the second synchronization island; and
automatically overwrite the priority parameter of the acquired announce message by a new priority parameter that indicates that the priority of the master clock of the second synchronization island is lower than the priority of the at least one master clock of the first synchronization island.

13. The apparatus of claim 12, wherein the at least one memory and the computer program code are configured, with the at least one processor, to cause the apparatus to determine the new priority parameter by accumulating an original priority parameter contained in the acquired announce message by a predetermined amount.

14. The apparatus of claim 12, wherein the at least one memory and the computer program code are configured, with the at least one processor, to cause the apparatus to:
determine whether a best master clock selection algorithm used by the apparatus uses at least one other criterion that prevails over said priority of the master clocks in the algorithm and, if such criteria is provided, determining operational parameters that affect the at least one other criterion; and
overwrite parameter values of the determined operational parameters in the acquired announce message with parameter values that are equal to or poorer than the corresponding parameter values of the master clock of the first synchronization island.

15. The apparatus of claim 12, wherein the at least one memory and the computer program code are configured, with the at least one processor, to cause the apparatus to:
determine whether a best master clock selection algorithm used in the apparatus uses at least one other criterion that prevails over said priority of the master clocks in the algorithm and, if such criteria is provided, determining operational parameters that affect the at least one other criterion; and
overwrite parameter values of the determined operational parameters in the acquired announce message with parameter values that are equal to the corresponding parameter values of a master clock of a third synchronization island also connected to the first synchronization island.

16. The apparatus of claim 14, wherein the at least one criterion that prevails over said priority of the master clocks in the algorithm comprises at least one of the following: a manual master clock priority, a master clock classification, a master clock accuracy, and a master clock stability.

17. The apparatus of claim 12, wherein the at least one memory and the computer program code are configured, with the at least one processor, to cause the apparatus to:
assume a domain number of the first synchronization island which is different from a domain number of the second synchronization island; and
overwrite a domain number parameter of the acquired announce message with a value that is equal to a domain number parameter value of the first synchronization island.

18. The apparatus of claim 12, wherein the at least one memory and the computer program code are configured, with the at least one processor, to cause the apparatus to use thus modified contents of the acquired announce message in a master clock selection algorithm configured to select a master clock for the apparatus.

19. The apparatus of claim 12, wherein the at least one memory and the computer program code are configured, with the at least one processor, to cause the apparatus to forward thus modified contents of the announce message towards the first synchronization island.

20. The apparatus of claim 19, wherein the at least one memory and the computer program code are configured, with the at least one processor, to cause the apparatus to:
execute, before forwarding the modified contents of the announce message towards the first synchronization domain, a master clock selection algorithm in which the master clock of the second synchronization island is compared with a master clock of the first synchronization island;
upon determining on the basis of the master clock selection algorithm that the master clock of the second synchronization island is capable of providing a better synchronization reference than the master clock of the first synchronization island, forward the modified contents of the announce message in the first synchronization island; and
upon determining on the basis of the master clock selection algorithm that the master clock of the first synchronization island is capable of providing a better synchronization reference than the master clock of the second synchronization island, prevent the forwarding of the modified contents of the announce message in the first synchronization island.

21. The apparatus of claim 12, wherein the at least one memory and the computer program code are configured, with the at least one processor, to cause the apparatus to forward the announce message with the modified contents towards the first synchronization island.

22. The apparatus of claim 12, wherein the priority parameter is Priority 2 parameter of precision time protocol according to IEEE 1588 specification.

23. An apparatus, comprising means for carrying out all the steps of the method claim 1.

24. A computer program product embodied on a distribution medium readable by a computer and comprising program instructions which, when loaded into an apparatus, execute the method according to claim 1.
